(19) United States
(12) Patent Application Publication
(10) Pub. No.: US 2015/0148225 A1
(43) Pub. Date: May 28, 2015

(54) Systems and Methods for Managing a Synergistic Relationship Between PGM and Copper-Manganese in a Three Way Catalyst Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES INC. (CDTI), Ventura, CA (US)

(21) Appl. No.: 14/090,938

(22) Filed: Nov. 26, 2013

(51) Int. Cl. B01J 23/89

(52) U.S. Cl. CPC B01J 23/8986
USPC 502/324

(57) ABSTRACT

Synergized Platinum Group Metals (SPGM) catalyst systems for TWC application are disclosed. Disclosed SPGM catalyst systems may include a washcoat with a Cu—Mn spinel structure, Cu_{1.0}Mn_{2.0}O₄, supported on Nb₂O₅—ZrO₂ and an overcoat that includes PGM supported on carrier material oxides, such as alumina. SPGM catalyst system that includes the spinel structure of Cu_{1.0}Mn_{2.0}O₄ show significant improvement in nitrogen oxide reduction performance under stoichiometric operating conditions and especially under lean operating conditions, which allows a reduced consumption of fuel. Additionally, disclosed SPGM catalyst system with spinel structure of Cu_{1.0}Mn_{2.0}O₄ also enhances the reduction of carbon monoxide and hydrocarbon within catalytic converters. Furthermore, disclosed SPGM catalyst systems are found to have enhanced catalyst activity compared to same catalyst system that do not include Cu—Mn spinel catalysts, showing that there is a synergistic effect among PGM catalyst and Cu—Mn stoichiometric spinel structure within the disclosed SPGM catalyst system.

### CROSS-REFERENCE TO RELATED APPLICATIONS

The present disclosure is related to U.S. patent application Ser. No. 14/090,861, entitled “System and Methods for Using Synergized PGM as a Three-Way Catalyst”, and U.S. patent application Ser. No. 14/090,887, entitled “Oxygen Storage Capacity and Thermal Stability of Synergized PGM Catalyst System”, as well as U.S. patent application Ser. No. 14/090,915, entitled “Method for Improving Lean performance of PGM Catalyst Systems: Synergized PGM”, all filed Nov. 26, 2013, the entireties of which are incorporated by reference as if fully set forth herein.

### BACKGROUND

1. Technical Field

The present disclosure relates generally to PGM catalyst systems, and, more particularly, to synergized PGM by copper-manganese.

2. Background Information

Catalysts in catalytic converters have been used to decrease the pollution caused by exhaust from various sources, such as automobiles, utility plants, processing and manufacturing plants, airplanes, trains, all-terrain vehicles, boats, mining equipment, and other engine-equipped machines. Important pollutants in the exhaust gas of internal combustion engines may include carbon monoxide (CO), unburned hydrocarbons (HC), nitrogen oxides (NOx), and particulate matter (PM). Several oxidation and reduction reactions take place in the catalytic converter, which is capable of removing the major pollutants HC, CO and NO_{X} simultaneously, therefore, it is called a three-way catalyst.

Catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters. Additionally, engines associated with TWC using PGM operate at or near stoichiometric conditions.

For the foregoing reasons, there is a need for combined catalyst systems that include low amounts of PGM catalysts, which may have facile nature of the redox function of the used chemical components, and which may exhibit improved performance especially under lean condition in order to allow fuel economy. Therefore, there is a need to find synergistic elements for PGM catalysts yielding enhanced activity.

### SUMMARY

The present disclosure provides Synergized Platinum Group Metals (SPGM) catalyst systems which may exhibit high catalyst activity, especially under lean condition, and thus enhanced NO, CO and HC conversion. The present disclosure demonstrates the improved activity of SPGM catalyst is result of optimal synergistic relationship between copper-manganese spinel and PGM catalyst in TWC application.

According to embodiments of the present disclosure, a synergized PGM (SPGM) catalyst system is disclosed, which may be configured with a washcoat layer including Cu—Mn spinel (Cu_{1.0}Mn_{2.0}O₄) with niobium-zirconia support oxide (Nb₂O₅—ZrO₂), and an overcoat layer including PGM catalyst, such as palladium (Pd) with alumina-based support, and suitable ceramic substrate.

To determine the synergistic relationship between PGM and Cu—Mn spinel, a PGM catalyst system with a washcoat layer including only niobium-zirconia support oxide (Nb₂O₅—ZrO₂), and an overcoat layer including PGM catalyst, such as palladium (Pd) with alumina-based support, and suitable ceramic substrate is also disclosed.

Disclosed catalyst systems may be prepared using suitable known in the art synthesis method, such as co-milling process, and co-precipitation process, among others.

The optimal NO conversion of disclosed SPGM catalyst systems that includes Cu—Mn spinel and PGM catalyst system that do not include Cu—Mn spinel may be determined by performing isothermal steady state sweep test, steady state and oscillating light-off tests, employing fresh samples of SPGM catalyst system with Cu—Mn spinel and fresh samples of PGM system without Cu—Mn spinel prepared according to embodiments in the present disclosure. Results from isothermal steady state sweep tests and light off tests may be compared to show the optimal synergistic relationship between PGM and Cu—Mn spinel for optimal performance under TWC condition, particularly under lean condition to reduce fuel consumption using the disclosed SPGM catalyst system.

Additionally, T50 of disclosed SPGM catalyst system may be determined by TWC standard light-off test at different R-value under steady state and oscillating conditions.

It may be found from the present disclosure that although the catalytic activity of a catalyst during real use may be affected by factors such as the chemical composition of the catalyst, as PGM catalysts usually work close to stoichiometric condition, it is desirable to increase catalyst activity under lean condition. Under lean condition NO_{X} conversion may be increased by synergizing PGM catalysts with Cu—Mn stoichiometric spinel (Cu_{1.0}Mn_{2.0}O₄). This synergistic effect on PGM catalyst may improve fuel consumption and provide fuel economy. The TWC property of the disclosed SPGM catalyst system may provide an indication of optimal synergistic effect between PGM and copper-manganese spinel oxide.

Numerous other aspects, features and benefits of the present disclosure may be made apparent from the following detailed description taken together with the drawing figures.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows a SPGM catalyst system configuration with Cu—Mn spinel referred as SPGM catalyst system Type 1, according to an embodiment.

FIG. 2 illustrates a PGM catalyst system configuration with no Cu—Mn spinel referred as catalyst system Type 2, according to an embodiment.

FIG. 3 illustrates steady state light-off test comparison for fresh samples of SPGM catalyst system Type 1 and PGM catalyst system Type 2 under TWC gas condition and SV of 40,000 h⁻¹ and an R-value of 1.2, according to an embodiment.

FIG. 4 illustrates steady state light-off test comparison for fresh samples of SPGM catalyst system Type 1 and PGM catalyst system Type 2 under TWC gas condition and SV of 40,000 h⁻¹ and an R-value of 1.05, according to an embodiment.

FIG. 5 illustrates steady state light-off test comparison for fresh samples of SPGM catalyst system Type 1 and PGM catalyst system Type 2 under TWC gas condition and SV of 90,000 h⁻¹ and an R-value of 1.05, according to an embodiment.

FIG. 6 shows TWC performance for fresh samples of SPGM catalyst system Type 1 and PGM catalyst system Type 2 under isothermal steady state sweep condition, at inlet temperature of about 450° C. and SV of about 40,000 h⁻¹, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used here, the following terms may have the following definitions:

“Catalyst system” refers to a system of at least two layers including at least one substrate, a washcoat, and/or an overcoat.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat layer.

“Catalyst” refers to one or more materials that may be of use in the conversion of one or more other materials.

“Milling” refers to the operation of breaking a solid material into a desired grain or particle size.

“Co-precipitation” refers to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Platinum group metals (PGM)” refers to platinum, palladium, ruthenium, iridium, osmium, and rhodium.

“Synergized platinum group metal (SPGM) catalyst” refers to a PGM catalyst system which is synergized by a non-PGM group metal compound under different configuration.

“Spinel” refers to any of various mineral oxides of with AB₂O₄ structure.

“Treating,” “treated,” or “treatment” refers to drying, firing, heating, evaporating, calcining, or mixtures thereof.

“Three-Way Catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“R-Value” refers to the number obtained by dividing the reducing potential by the oxidizing potential.

“Lean condition” refers to exhaust gas condition with an R-value below 1.

“Stoichiometric condition” refers to the condition when the oxygen of the combustion gas or air added equals the amount for completely combusting the fuel.

“T₅₀” may refer to the temperature at which 50% of a material is converted.

“T₉₀” may refer to the temperature at which 90% of a material is converted.

“Conversion” refers to the chemical alteration of at least one material into one or more other materials.

### DESCRIPTION OF THE DRAWINGS

The present disclosure may generally provide a synergized PGM (SPGM) catalyst system having enhanced catalytic performance, incorporating more active components into phase materials possessing three-way catalyst (TWC) properties, such as improved oxygen mobility, to enhance the catalytic activity of the disclosed SPGM catalyst system.

According to embodiments in the present disclosure, SPGM catalyst systems may be configured with a washcoat layer including Cu—Mn spinel with Niobium-Zirconia support oxide, an overcoat layer including a PGM catalyst of palladium (Pd) with alumina-based support, and suitable ceramic substrate, here referred as SPGM catalyst system Type 1. According to embodiments in the present disclosure, PGM catalyst systems may be configured with WC layer including Niobium-Zirconia support oxide, an OC layer including PGM catalyst of Pd with alumina-based support, and suitable ceramic substrate, here referred as PGM catalyst system Type 2.

Catalyst System Configuration

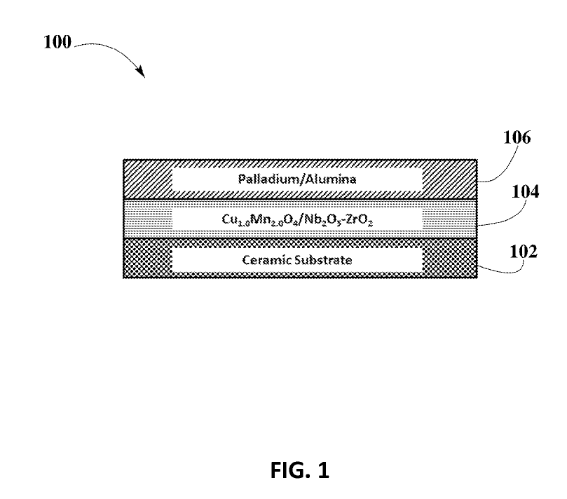

FIG. 1 shows a SPGM catalyst system configuration referred as SPGM catalyst system Type 1 100, according to an embodiment.

As shown in FIG. 1, SPGM catalyst system Type 1 100 may include at least a substrate 102, a washcoat 104, and an overcoat 106, where washcoat 104 may include a Cu—Mn spinel structure, Cu_{1.0}Mn_{2.0}O₄, supported on Nb₂O₅—ZrO₂ and overcoat 106 may include PGM catalyst, such as Palladium (Pd) supported on carrier material oxides, such as alumina.

In an embodiment, substrate 102 materials for SPGM catalyst system Type 1 100 may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art. According to the present disclosure, preferred substrate 102 materials may be ceramic material.

According to an embodiment, washcoat 104 for SPGM catalyst system Type 1 100 may include a Cu—Mn stoichiometric spinel, Cu_{1.0}Mn_{2.0}O₄, as metal catalyst. Additionally, washcoat 104 may include support oxide, such as Nb₂O₅—ZrO₂.

According to embodiments of the present disclosure, overcoat 106 for SPGM catalyst system Type 1 100 may include aluminum oxide, doped aluminum oxide, zirconium oxide, doped zirconia, titanium oxide, tin oxide, silicon dioxide, zeolite, and mixtures thereof. According to the present disclosure, most suitable material for disclosed overcoat 106 may be alumina (Al₂O₃). Additionally, overcoat 106 for SPGM catalyst system Type 1 100 may include a PGM catalyst, such as Palladium (Pd), Platinum (Pt), Rhodium (Rh). According to the present disclosure, most suitable PGM for disclosed overcoat 106 may be Pd.

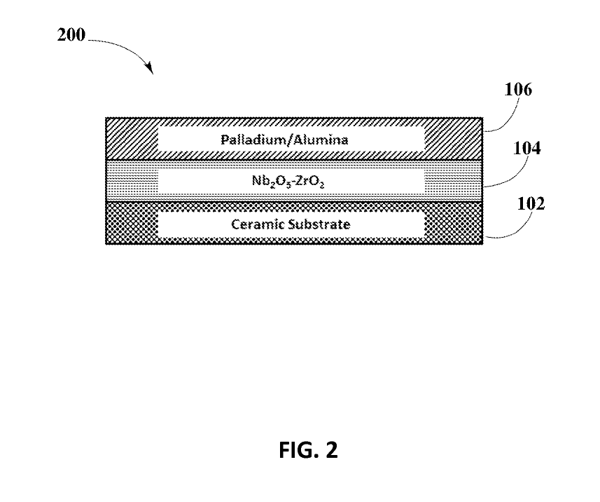

FIG. 2 illustrates a PGM catalyst system configuration referred as PGM catalyst system Type 2 200, according to an embodiment.

As shown in FIG. 2, PGM catalyst system Type 2 200 may include at least a substrate 102, a washcoat 104, and an overcoat 106, where washcoat 104 may include Nb₂O₅—ZrO₂ and overcoat 106 may include carrier material oxides, such as alumina mixed with a PGM catalyst, such as Palladium (Pd).

In an embodiment, substrate 102 materials for PGM catalyst system Type 2 200 may include a refractive material, a ceramic material, a honeycomb structure, a metallic material, a ceramic foam, a metallic foam, a reticulated foam, or suitable combinations, where substrate 102 may have a plurality of channels with suitable porosity. Porosity may vary according to the particular properties of substrate 102 materials. Additionally, the number of channels may vary depending upon substrate 102 used as is known in the art. The type and shape of a suitable substrate 102 would be apparent to one of ordinary skill in the art. According to the present disclosure, preferred substrate 102 materials may be ceramic material.

According to an embodiment, washcoat 104 for PGM catalyst system Type 2 200 may include only a support oxide, such as Nb₂O₅—ZrO₂.

According to embodiments of the present disclosure, overcoat 106 for PGM catalyst system Type 2 200 may include aluminum oxide, doped aluminum oxide, zirconium oxide, doped zirconia, titanium oxide, tin oxide, silicon dioxide, zeolite, and mixtures thereof. According to the present disclosure, most suitable material for disclosed overcoat 106 may be alumina (Al₂O₃). Additionally, overcoat 106 for PGM catalyst system Type 2 200 may include a PGM catalyst, such as Palladium (Pd).

According to embodiments of the present disclosure PGM catalyst system Type 2 200 has the same configuration as SPGM catalyst system Type 1 100 in which Cu—Mn spinel is removed from washcoat 104 layer, thus demonstrating the effect of addition of Cu—Mn spinel to PGM catalyst system.

Preparation of SPGM Catalyst System Type 1 with Cu—Mn Spinel

The preparation of washcoat 104 may begin by co-milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% by weight to about 15% by weight. Suitable manganese loadings may include loadings in a range of about 15% by weight to about 25% by weight. The next step is precipitation of Cu—Mn nitrate solution on Nb₂O₅—ZrO₂ support oxide aqueous slurry, which may have a suitable base solution added thereto, such as to adjust the pH of the slurry to a suitable range. The precipitated Cu—Mn/Nb₂O₅—ZrO₂ slurry may be aged for a period of time of about 12 to 24 hours under continued stirring at room temperature.

Subsequently, the precipitated slurry may be coated on substrate 102, using a cordierite material with honeycomb structure, where substrate 102 may have a plurality of channels with suitable porosity. The aqueous slurry of Cu—Mn/Nb₂O₅—ZrO₂ may be deposited on the suitable ceramic substrate 102 to form washcoat 104, employing vacuum dosing and coating systems. In the present disclosure, a plurality of capacities of washcoat 104 loadings may be coated on the suitable ceramic substrate 102. The plurality of washcoat 104 loading may vary from about 60 g/L to about 200 g/L, in the present disclosure particularly about 120 g/L. Subsequently, after deposition on ceramic substrate 102 of the suitable loadings of Cu—Mn/Nb₂O₅—ZrO₂ slurry, washcoat 104 may be dried overnight at about 120° C. and subsequently calcined at a suitable temperature within a range of about 550° C. to about 650° C., preferably at about 600° C. for about 5 hours. Treatment of washcoat 104 may be enabled employing suitable drying and heating processes. A commercially-available air knife drying systems may be employed for drying washcoat 104. Heat treatments (calcination) may be performed using commercially-available firing (furnace) systems.

A suitable washcoat 104 deposited on substrate 102 may have a chemical composition with a total loading of about 120 g/L, including a Cu—Mn spinel structure with copper loading of about 10 g/L to about 15 g/L and manganese loading of about 20 g/L to about 25 g/L.

Overcoat 106 may include a combination of Pd on alumina-based support. The preparation of overcoat 106 may begin by milling the alumina-based support oxide separately to make an aqueous slurry. Subsequently, a solution of Pd nitrate may then be mixed with the aqueous slurry of alumina with a loading within a range from about 0.5 g/ft³ to about 10 g/ft³. In the present embodiment, Pd loading is about 6 g/ft³ and total loading of WC material is 120 g/L. After mixing of Pd and alumina slurry, Pd may be locked down with an appropriate amount of one or more base solutions, such as sodium hydroxide (NaOH) solution, sodium carbonate (Na₂CO₃) solution, ammonium hydroxide (NH₄OH) solution, tetraethyl ammonium hydroxide (TEAH) solution, amongst others. In the present embodiment, Pd may be locked down using a base solution of tetraethyl ammonium hydroxide (TEAH). No pH adjustment is required. Then, the resulting slurry may be aged from about 12 hours to about 24 hours for subsequent coating as overcoat 106 on washcoat 104, dried and fired at about 550° C. for about 4 hours.

Preparation of PGM Catalyst System Type 2 with no Cu—Mn spinel

The preparation of washcoat 104 may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

Subsequently, the aqueous slurry of Nb₂O₅—ZrO₂ may be coated on substrate 102, using a cordierite material with honeycomb structure, where substrate 102 may have a plurality of channels with suitable porosity. The aqueous slurry of Nb₂O₅—ZrO₂ may be deposited on the suitable ceramic substrate 102 to form washcoat 104, employing vacuum dosing and coating systems. In the present disclosure, a plurality of capacities of washcoat 104 loadings may be coated on the suitable ceramic substrate 102. The plurality of washcoat 104 loading may vary from about 60 g/L to about 200 g/L, in the present disclosure particularly about 120 g/L. Subsequently, after deposition on ceramic substrate 102 of the suitable loadings of Nb₂O₅—ZrO₂ slurry, washcoat 104 may be dried and calcined at a suitable temperature within a range of about 500° C. to about 600° C., preferably at about 550° C. for about 4 hours. Treatment of washcoat 104 may be enabled employing suitable drying and heating processes. A commercially-available air knife drying systems may be employed for drying washcoat 104. Heat treatments (calcination) may be performed using commercially-available firing (furnace) systems.

Overcoat 106 may include a combination of Pd on alumina-based support. The preparation of overcoat 106 may begin by milling the alumina-based support oxide separately to make an aqueous slurry. Subsequently, a solution of Pd nitrate may then be mixed with the aqueous slurry of alumina with a loading within a range from about 0.5 g/ft³ to about 10 g/ft³. In the present embodiment, Pd loading is about 6 g/ft³ and total loading of WC material is 120 g/L. After mixing of Pd and alumina slurry, Pd may be locked down with an appropriate amount of one or more base solutions, such as sodium hydroxide (NaOH) solution, sodium carbonate (Na₂CO₃) solution, ammonium hydroxide (NH₄OH) solution, tetraethyl ammonium hydroxide (TEAH) solution, amongst others. In the present embodiment, Pd may be locked down using a base solution of tetraethyl ammonium hydroxide (TEAH). No pH adjustment is required. Then, the resulting slurry may be aged from about 12 hours to about 24 hours for subsequent coating as overcoat 106 on washcoat 104, dried and fired at about 550° C. for about 4 hours.

In order to compare TWC performance of disclosed SPGM catalyst system Type 1 100 and PGM catalyst system Type 2 200, steady state and oscillating light-off tests may be performed.

TWC Performance Comparison of SPGM Catalyst System Type 1 and PGM Catalyst System Type 2

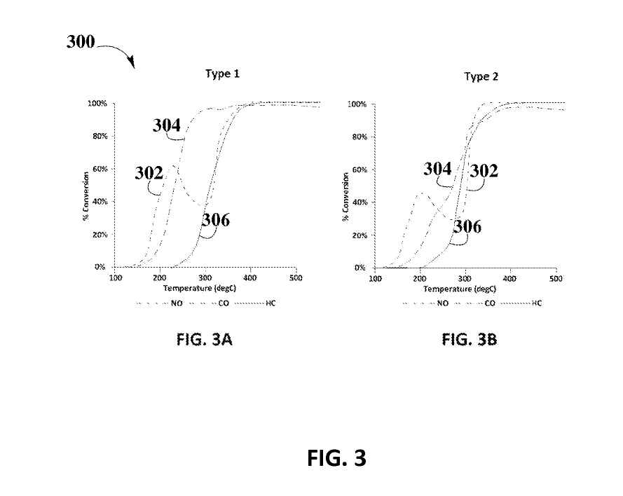

FIG. 3 illustrates steady state light-off test comparison 300 for fresh samples of SPGM catalyst system Type 1 100 and PGM catalyst system Type 2 200, where steady state light-off test was performed rich condition with R-value of 1.20. Steady state light-off test has been performed employing a test reactor with space velocity of about 40,000 hr−1, at temperature range of 100° C. to about 500° C., increasing with a rate of about 40 C/min with gas composition in feed stream of 8,000 ppm of CO, 400 ppm of C₃H₆, 100 ppm of C₃H₈, 1,000 ppm of NO_{R}, 2,000 ppm of H₂, 10% of CO₂, 10% of H₂O, and varied O₂ content to adjust R-value at 1.2.

In order to facilitate comparison, NO conversion curve 302 has been designated with dash lines, CO conversion curve 304 has been designated with dot and dash lines, and HC conversion curve 306 has been designated with a solid line.

Performance in NO, CO, and HC conversion for SPGM catalyst system Type 1 100 is shown in FIG. 3A, where T50 of NO occurs at temperature of about 202.2° C., where the NO conversion reaches to 50%. T50 of CO occurs at temperature of about 217.8° C., where the CO conversion reaches to 50%. T50 of HC occurs at temperature of about 291.0° C., where the HC conversion reaches to 50%.

Moreover, as may be observed in FIG. 3B, for fresh samples of PGM catalyst system Type 2 200, T50 of NO occurs at temperature of about 293.7° C., where the NO conversion reaches to 50%. T50 of CO occurs at temperature of about 263.0° C., where the CO conversion reaches to 50%. T50 of HC occurs at temperature of about 279.9° C., where the HC conversion reaches to 50%.

According to principles of the present disclosure, fresh samples of SPGM catalyst system Type 1 100 demonstrated higher catalytic activity in rich TWC condition compared to fresh samples of PGM catalyst system Type 2 200. Especially NO and CO conversion may take place within a lower temperatures when SPGM catalyst system Type 1 100 is employed. The T50 of NO decreased approximately 91° C. in SPGM catalyst system Type 1 100 with Cu—Mn spinel compared to PGM catalyst system Type 2 200, in which Cu—Mn spinel was removed from WC layer. The improvement observed in disclosed SPGM catalyst is certainly from Cu—Mn synergic effect on Pd.

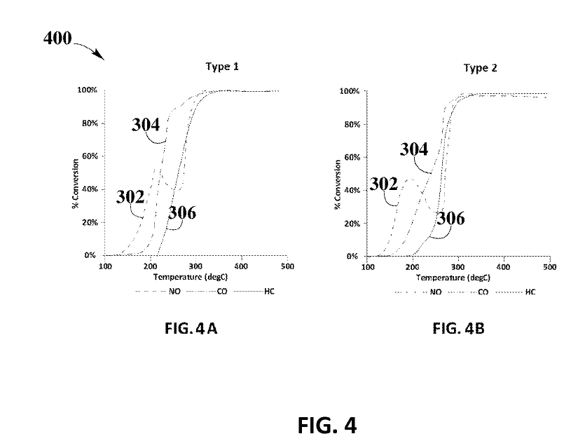

FIG. 4 illustrates steady state light-off test comparison 400 for fresh samples of SPGM catalyst system Type 1 100 and PGM catalyst system Type 2 200, where steady state light-off test was performed at stoichiometric condition with R-value of 1.05. Steady state light-off test has been performed employing a test reactor with space velocity of about 40,000 hr−1, at temperature range of 100° C. to about 500° C., increasing with a rate of about 40 C/min with gas composition in feed stream of 8,000 ppm of CO, 400 ppm of C₃H₆, 100 ppm of C₃H₈, 1,000 ppm of NO_{R}, 2,000 ppm of H₂, 10% of CO₂, 10% of H₂O, and varied O₂ to adjust R-value at 1.05.

In order to facilitate comparison, NO conversion curve 302 has been designated with dash lines, CO conversion curve 304 has been designated with dot and dash lines, and HC conversion curve 306 has been designated with a solid line.

Performance in NO, CO, and HC conversion for SPGM catalyst system Type 1 100 is shown in FIG. 4A, where T50 of NO occurs at temperature of about 211.9° C., where the NO conversion reaches to 50%. T50 of CO occurs at temperature of about 228.1° C., where the CO conversion reaches to 50%. T50 of HC occurs at temperature of about 265.9° C., where the HC conversion reaches to 50%.

Moreover, as may be observed in FIG. 4B, for fresh samples of PGM catalyst system Type 2 200, T50 of NO occurs at temperature of about 277.4° C., where the NO conversion reaches to 50%. T50 of CO occurs at temperature of about 242.6° C., where the CO conversion reaches to 50%. T50 of HC occurs at temperature of about 266.0, where the HC conversion reaches to 50%.

According to principles of the present disclosure, fresh samples of SPGM catalyst system Type 1 100 demonstrated higher catalytic activity in stoichiometric TWC condition compared to fresh samples of PGM catalyst system Type 2 200. Therefore, NO, and CO conversion may take place within a lower temperatures when SPGM catalyst system Type 1 100 is employed. The T50 of NO decreased approximately 65° C. in SPGM catalyst system Type 1 100 with Cu—Mn spinel compared to PGM catalyst system Type 2 200, in which Cu—Mn spinel was removed from washcoat 104 layer. The improvement observed in disclosed SPGM catalyst is certainly from Cu—Mn synergic effect on Pd.

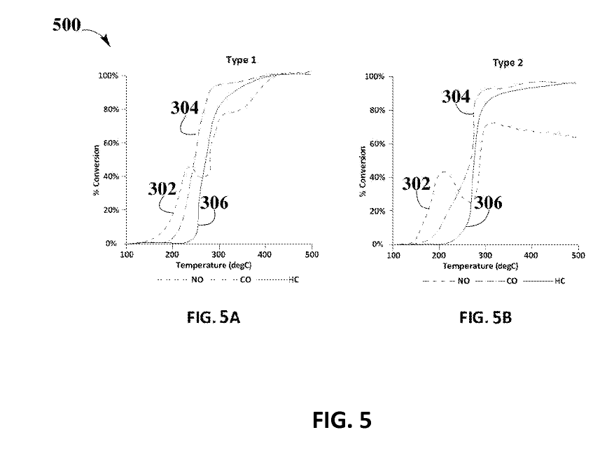

FIG. 5 illustrates Oscillating light-off test comparison 500 for fresh samples of SPGM catalyst system Type 1 100 and PGM catalyst system Type 2 200. TWC standard oscillating light-off test may be carried out employing a flow reactor in which temperature may be increased from about 100° C. to about 500° C. at a rate of about 40° C./min, feeding a gas composition of 8,000 ppm of CO, 400 ppm of C₃H₆, 100 ppm of C₃H₈, 1,000 ppm of NO_{R}, 2,000 ppm of H₂, 10% of CO₂, 10% of H₂O, and O₂ quantity is variable between 0.3% to 0.45% for oscillating. The average R-value is 1.05 (stoichiometric) at SV of about 90,000 h⁻¹. Oscillating light-off test may be conducted, under a frequency of about 1 Hz with ±0.4 A/F ratio span.

In order to facilitate comparison, NO conversion curve 302 has been designated with dash lines, CO conversion curve 304 has been designated with dot and dash lines, and HC conversion curve 306 has been designated with a solid line.

Performance in NO, CO, and HC conversion for SPGM catalyst system Type 1 100 is shown in FIG. 5A, where T50 of NO occurs at temperature of about 295.4° C., where the NO conversion reaches to 50%. T50 of CO occurs at temperature of about 257.3° C., where the CO conversion reaches to 50%. T50 of HC occurs at temperature of about 286.9° C., where the HC conversion reaches to 50%.

Moreover, as may be observed in FIG. 5B, for fresh samples of PGM catalyst system Type 2 200, T50 of NO occurs at temperature of about 291.4° C., where the NO conversion reaches to 50%. T50 of CO occurs at temperature of about 268.6° C., where the CO conversion reaches to 50%. T50 of HC occurs at temperature of about 280.0° C., where the HC conversion reaches to 50%.

According to principles of the present disclosure, fresh samples of SPGM catalyst system Type 1 100 demonstrated higher catalytic activity in oscillating TWC condition compared to fresh samples of PGM catalyst system Type 2 200 at higher temperature. The T50 of NO, CO and HC conversion may take place within a same temperatures for both SPGM catalyst system Type 1 100 and PGM catalyst system Type 2 200. However, the T90 of NO conversion, where NO conversion is 90% does not take place in PGM catalyst system Type 2 200, in which Cu—Mn spinel was removed from washcoat layer. T90 of NO for SPGM catalyst system Type 1 100 with Cu—Mn spinel is approximately 410° C. The improvement observed in disclosed SPGM catalyst is certainly from Cu—Mn synergic effect on Pd.

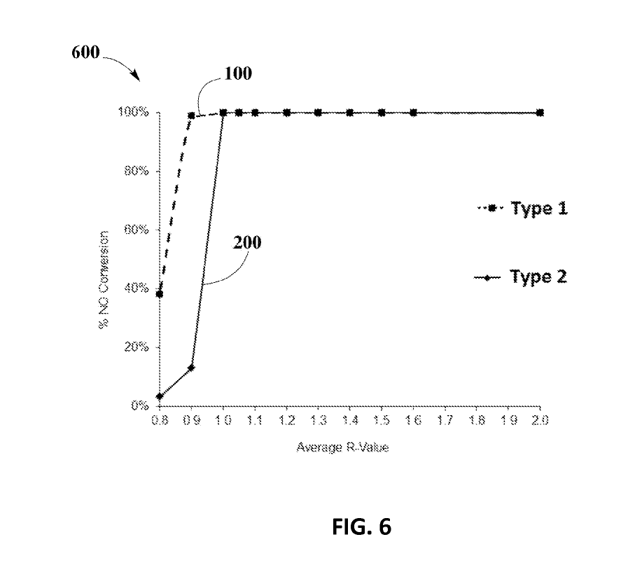

FIG. 6 shows TWC performance for fresh samples of SPGM catalyst system Type 1 100 and PGM catalyst system Type 2 200 where the isothermal steady state sweep test 600 may be carried out employing a flow reactor in which the inlet temperature may be increased to about 450° C., and testing a gas stream at 11-point R-values from about 2.0 (rich condition) to about 0.80 (lean condition) to measure NO conversions.

The space velocity (SV) in the flow reactor may be adjusted to about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NO_{R}, about 2,000 ppm of H₂, 10% of CO₂, and 10% of H₂O. The quantity of O₂ in the gas mix may be varied to adjust Air/Fuel (A/F) ratio and to represent the three-way condition of the control loop.

As may be seen in FIG. 6, NO conversion curve 302, shows that the NO conversion fresh samples of SPGM catalyst system Type 1 100 takes place at lower R-value compered to PGM catalyst system Type 2 200. The PGM catalyst system Type 2 200 without Cu—Mn spinel shows 100% of NO conversion at approximately R-value of 1.00, which was expected for PGM catalyst systems. However, SPGM catalyst system Type 1 100 shows higher NO conversion at R-value below 1.0 (lean region), in which 100% NO conversion is obtained at R-value of about 0.950. FIG. 6 certainly shows the improved NO conversion of disclosed SPGM catalyst system Type 1 100 under lean condition, for example at a lean R-value of 0.88, SPGM catalyst system Type 1 100 shows 90% of NO conversion, and PGM catalyst system Type 2 200 shows NO conversion of 12%. Thus, demonstrating PGM catalyst system Type 2 200 with no Cu—Mn spinel does not perform as good as PGM with Cu—Mn spinel (SPGM catalyst system Type 1 100), especially under lean condition.

As may be observed in performance comparison between SPGM catalyst system Type 1 100 and PGM catalyst system Type 2 200, shown in FIG. 6, there is an improved performance in NO conversion under lean conditions for disclosed SPGM catalyst system Type 1 100. This improved performance is the result of the synergistic effect between the PGM component (palladium) and the Cu—Mn stoichiometric spinel structure, Cu_{1.0}Mn_{2.0}O₄, supported on Nb₂O₅—ZrO₂ in the respective composition of disclosed SPGM catalyst system Type 1 100, in which adding of Cu—Mn spinel is responsible for the improved performance of NO conversion. Since high performance under lean operating conditions allows less fuel consumption, then vehicles that employ disclosed SPGM catalyst system Type 1 100 consumes less fuel.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst system, comprising:
at least one substrate;
at least one washcoat comprising at least one oxygen storage material further comprising Cu—Mn spinel having a niobium-zirconia support oxide; and
at least one overcoat comprising at least one selected from the group comprising platinum group metal catalyst, Al₂O₃, and mixtures thereof;
wherein the catalyst system has a T50 value of less than 300° C.

2. The catalyst system of claim 1, wherein the Cu—Mn spinel comprises CuMn₂O₄.

3. The catalyst system of claim 1, wherein the Cu—Mn spinel is stoichiometric.

4. The catalyst system of claim 1, wherein the niobium-zirconia support oxide comprises Nb₂O₅—ZrO₂.

5. The catalyst system of claim 1, further comprising at least one impregnation layer.

6. The catalyst of claim 1, wherein the at least one substrate comprises a ceramic.

7. The catalyst of claim 1, wherein the conversion of NO is substantially complete under lean exhaust conditions.

8. The catalyst of claim 1, wherein the conversion of CO is substantially complete under lean exhaust conditions.

9. The catalyst of claim 1, wherein the conversion of NO is near 95% under lean exhaust conditions.

10. The catalyst of claim 1, wherein the conversion of NO is improved over a catalyst system comprising at least one platinum group metal catalyst and substantially no Cu—Mn spinel.

11. The catalyst of claim 1, wherein the NO cross over R-value is about 0.950.

12. The catalyst of claim 1, wherein the CO cross over R-value is about 0.965.

13. A catalyst system, comprising:
at least one substrate;
at least one washcoat comprising at least one selected from the group comprising platinum group metal catalyst, Al₂O₃, and mixtures thereof; and
at least one overcoat comprising at least one oxygen storage material further comprising Cu—Mn spinel having a niobium-zirconia support oxide;
wherein the catalyst system has a T50 value of less than 300° C.

14. The catalyst system of claim 13, wherein the Cu—Mn spinel comprises CuMn₂O₄.

15. The catalyst system of claim 13, wherein the Cu—Mn spinel is stoichiometric.

16. The catalyst system of claim 13, wherein the niobium-zirconia support oxide comprises Nb₂O₅—ZrO₂.

17. The catalyst system of claim 13, further comprising at least one impregnation layer.

18. The catalyst of claim 13, wherein the at least one substrate comprises a ceramic.

19. The catalyst of claim 13, wherein the conversion of NO is substantially complete under lean exhaust conditions.

20. The catalyst of claim 13, wherein the conversion of CO is substantially complete under lean exhaust conditions.

21. The catalyst of claim 13, wherein the conversion of NO is improved over a catalyst system comprising at least one platinum group metal catalyst and substantially no Cu—Mn spinel.

22. A catalyst system, comprising:
at least one substrate comprising ceramics;
at least one washcoat comprising Al₂O₃;
at least one overcoat comprising at least one oxygen storage material further comprising Cu—Mn spinel having a niobium-zirconia support oxide; and
at least one impregnation layer comprising at least one platinum group metal catalyst;
wherein the at least one platinum group metal catalyst comprises palladium; and
wherein the catalyst system has a T50 value of less than 300° C.
